(19) United States
(12) Patent Application Publication
(10) Pub. No.: US 2019/0112087 A1
(43) Pub. Date: Apr. 18, 2019

(54) METHOD AND PACKAGING MACHINE FOR PRODUCING A MULTIPACK

(71) Applicant: Multivac Marking & Inspection GmbH & Co. KG, Enger (DE)

(72) Inventors: Hauke FRIEDHOFF, Herford (DE); Georg AUSTERMEIER, Hövelhof (DE)

(21) Appl. No.: 16/157,474

(22) Filed: Oct. 11, 2018

(30) Foreign Application Priority Data
Oct. 12, 2017 (DE) 10 2017 123 706.2

(51) Int. Cl. B65B 35/50; B65G 57/16; B65D 21/02; B65D 25/20; B65C 1/04

(52) U.S. Cl. CPC B65B 35/50; B65G 57/16; B65G 2201/0235; B65D 25/205; B65C 1/04; B65D 21/0224

(57) ABSTRACT

A packaging machine for grouping individual package units, the packaging machine comprising a feeder, a conveying system, a grouping station and a labeler. The packaging machine is configured to stack at least three package units one on top of the other to form a package stack and to encompass the package stack, at least partially, with a label. The label may comprise one or two labels, wherein the label sections are pressed against the top of the package stack and folded around the side and bottom of the package stack to secure the sections together. The packaging machine may further comprises a press plunger that presses at least one hinge-like tab formed on a main surface of the label onto a side face of a central package unit of the package stack to further secure the packages in the stack.

### CROSS-REFERENCE TO RELATED APPLICATIONS

This Application claims priority to German Patent Application No. 10 2017 123 706.2 filed on Oct. 12, 2017 to Hauke Friedhoff and Georg Austermeier, currently pending, the entire disclosure of which is incorporated herein by reference.

### FIELD OF THE INVENTION

The present invention relates to a method and a packaging machine for producing package stacks, so-called multipacks, as well as to such package stacks themselves.

### BACKGROUND OF THE INVENTION

Sealed packages, in particular plastic packages, are used for a great variety of products. Often, food products are placed in or portioned into a thermoformed plastic tray and the tray is subsequently airtightly sealed with a plastic film using a heat-sealed seam, a welded seam or a pressure-sensitive adhesive seam. In order to allow stock-keeping on the part of the user, it becomes increasingly popular to sell a plurality of sealed package units as a stack, bundle or group. From this group, the individual package units can be removed and opened one after the other, while the remaining package units can still be stored in their originally sealed condition. This will ensure the keeping quality of the products contained therein. In addition, such bundles can be offered at an attractive price per package unit. Moreover, handling during purchase and transport is more convenient for the consumer.

The not yet published German patent application DE 10 2017 116 743 describes a device and a method for grouping individual packages.

### SUMMARY OF THE INVENTION

It is the object of the present invention to provide a method and a packaging machine for improved production of package stacks, so-called multipacks, as well as package stacks with improved properties, the packaging machine being intended to be suitable for use for a plurality of package types.

This object is achieved by a method for improving production of package stacks, a packaging machine for carrying out this method, and a package stack resulting from such method. Advantageous further developments of the invention are disclosed in the subclaims.

A packaging machine according to the present invention for grouping individual package units may comprise a feeder, a conveying system, a grouping station and a labeler. The packaging machine may be configured for stacking, using the grouping station, at least three package units one on top of the other so as to form a package stack and for encompassing the package stack, at least partially, with a label. The packaging machine further comprises a press plunger, which may be configured for pressing at least one hingelike tab of the label onto a side face of a central package unit of the package stack. For this purpose, the press plunger may be in particular smaller than or substantially equal in size to the tab. It may have a shape complementary to the side face of the central package unit and establish the adhesive connection between the tab and the side face by a single press-on movement corresponding substantially to a linear forward and backward movement. To this end, a respective suitable press plunger may be arranged in a replaceable manner. Alternatively, the press plunger may also be configured as a rotatable roller and may press-on the tab using a multi-axis movement. The packaging machine thus allows to produce a package stack consisting of package units, a so-called multipack, in which the package units are grouped in a stable manner. The tab may be configured such that the areal adhesive connection, which the tab can establish with a side face of the central package unit, may be larger than the thickness of the upper edge of the package unit in all dimensions. Due to the fact that the one or the plurality of central package units, i.e. those between an upper and a lower package unit, are connected to the tab(s) of the label using an adhesive connection, in particular an areal adhesive connection, also these central package units are fixed in position and secured against slipping out of the package stack.

According to a preferred embodiment, the labeler may be a cross web labeler; this means that a preferably elongate label may be applied transversely to the conveying direction. In this way, the package stack can, for example, be held between a front and a rear mover of the conveying system and the label can be applied without the movers, which project upwards beyond the package stack, interfering with the application of the label.

Preferably, the grouping station has two opposed toothed-belt conveyors with carrier strips and may be adjustable for grouping respective package units of different size. In this way, the grouping station can be adapted, in particular by simply adjusting the distance of the toothed-belt conveyors, to the sizes of the package units to be stacked. The toothed-belt conveyors preferably move substantially vertically, and, by adjusting the distances between the carrier strips along the toothed-belt conveyors, package units of different heights can be stacked and different stack heights can be realized.

According to an expedient variant, the conveying system comprises separately movable movers, which are controllable for fixing package units and/or package stacks between two respective movers in a force-fitting manner. The conveying system can flexibly be adapted to the production conditions, e.g. a predetermined or a desired production speed. In addition, the package stacks are conveyed reliably.

According to an advantageous variant, the conveying system has an opening, which allows the label to be pressed onto a lower surface of the package stack. As will be explained in more detail hereinafter, a label may be applied to a package stack such that it extends from an upper surface via a lateral side to a lower surface of the package stack. Due to the opening, a sufficiently large support surface for the package stack will remain in the middle, and it will also be possible to press the label onto a sufficiently large area of the lower surface, e.g. using a roller.

The package stack according to the present invention comprises an upper, a lower and at least one central package unit, which are stacked one on top of the other. The package stack further comprises at least one label that encompasses an upper surface, a lateral side and a lower sur-face of the package stack at least partially. The label comprises label edges and a main surface spaced apart from the label edges, the main surface comprising one or a plurality of tabs, which are connected to the main surface in a hingelike manner, the tabs being connected to a respective side face of a central package unit of the package stack using an areal bond. It follows that the label will not only keep the uppermost and the lowermost package unit connected by an adhesive bond, but, making use of the tab, it will also fix the central package units against slipping using an adhesive bond, in particular an areal adhesive bond. This means that, even if the package stack should be turned and tilted, all the package units will fixedly remain at their respective position and cannot slip out of the stack. The tab may be configured such that the areal adhesive bond, which the tab can establish with a side face of the central package unit, may be larger than the thickness of the upper edge of the package unit in all dimensions.

According to a preferred variant, the label has at least one perforation, which, when the label has been applied to a package stack, may be arranged preferably on the side in a horizontal direction. The perforation may be suitable to allow the package units to be separated from one another. Since the adhesive bonds of the label are normally very stable and since it may be difficult to peel off the label along an adhesive area, the label can be torn open along the perforation without any aids, such as scissors, and a single package unit can be removed from the stack.

A method according to the present invention, used for grouping at least three package units into a package stack, the method may comprise one or more of the following method steps: feeding the individual package units using a feeder to a grouping station; stacking the package units one on top of the other through the grouping station so as to form a package stack; depositing the package stack on a conveying system; feeding the package stack to a labeler through the conveying system; applying a label to the upper surface of the package stack through the labeler, the label having a lateral first projecting end that projects beyond the package stack; folding the first projecting end of the label round a first upper and a first lower edge of the package stack; pressing the first projecting end onto a lower surface of the package stack; pressing at least one tab, which may be connected to a main surface of the first projecting end in a hingelike manner, onto a side face of a central package unit of the package stack.

Preferably, the label has a lateral second projecting end and may be folded round a second upper edge and a second lower edge of the package stack. The second upper and the second lower edge are expediently located on the respective side located opposite the first upper and the first lower edge. Hence, the package stack may be encompassed on two opposed sides and the array of package units may be kept stable.

Typically, the second projecting end may be pressed onto the lower surface of the package stack.

According to a common variant, a second tab, which may be connected to a main surface of the second projecting end in a hingelike manner, may be pressed onto a side face of the central package unit of the package stack, in particular pressed on areally.

According to a further variant, a second label may be applied to the upper surface of the package stack, the second label having a lateral second projecting end that projects beyond the package stack. Since part of the upper surface of the package stack can remain free in this way, the imprint of the uppermost package unit can still be recognized, at least partially. In addition, material can be saved in this way.

Preferably, the second projecting end of the second label may be folded round a second upper and a second lower edge of the package stack. This means that either a single label may extend across two opposed sides of the stack to the lower surface of the latter, or one label out of two or out of a plurality of labels may extend across one of the two sides.

According to an expedient embodiment, the second projecting end of the second label may be pressed onto the lower surface of the package stack.

According to a preferred variant, a tab, which may be connected to the main surface of the second projecting end of the second label in a hingelike manner, may be pressed onto a side face of the central package unit of the package stack, in particular pressed on areally.

Other aspects and advantages of the present invention will be apparent from the following detailed description of the preferred embodiments and the accompanying drawing figures.

### DESCRIPTION OF THE SEVERAL VIEWS OF THE DRAWINGS

In the following, an advantageous embodiment of the present invention will be explained in more detail making reference to a drawing, in which the individual figures show:

FIG. 1 is a perspective side view of one embodiment of a packaging machine for grouping individual package units in accordance with the teachings of the present disclosure;

FIG. 2A is a perspective side view of one embodiment of a package stack in accordance with the teachings of the present disclosure and having a label with a first and a second projecting end, wherein the label is applied to the package stack's upper surface;

FIG. 2B is a perspective side view of the embodiment of the package stack of FIG. 2A having the first projecting end folded down around a first upper edge of the package stack, and a second projecting end folded down round a second upper edge of the package stack;

FIG. 2C is a perspective side view of the embodiment of the package stack of FIG. 2A having the projecting ends pressed on the lower surface of the package stack and a tab pressed on a side face of a central package unit;

FIG. 2D is a front view of the embodiment of the package stack of FIG. 2A having projecting ends of the label pressed on the lower surface of the package stack in accordance with FIG. 2C;

FIG. 3A is a front view of one embodiment of a label for a package stack in accordance with the teachings of the present disclosure having two tabs;

FIG. 3B is a perspective side view of the embodiment of the label of FIG. 3A;

FIG. 4A is a perspective side view of another embodiment of a package stack in accordance with the teachings of the present disclosure having a first projecting end of a first label folded down round a first upper edge and a second label folded down round a second upper edge;

FIG. 4B is a perspective side view of the package stack of FIG. 4A having projecting ends of the first and of the second label pressed on the lower surface of the package stack and one or more tabs pressed on the side faces of a the package stack;

FIG. 5A is a front view of one embodiment of a first label and a second label in accordance with the teachings of the present disclosure, each label including a tab; and

FIG. 5B is a perspective side view of the first label and second label of FIG. 5A.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

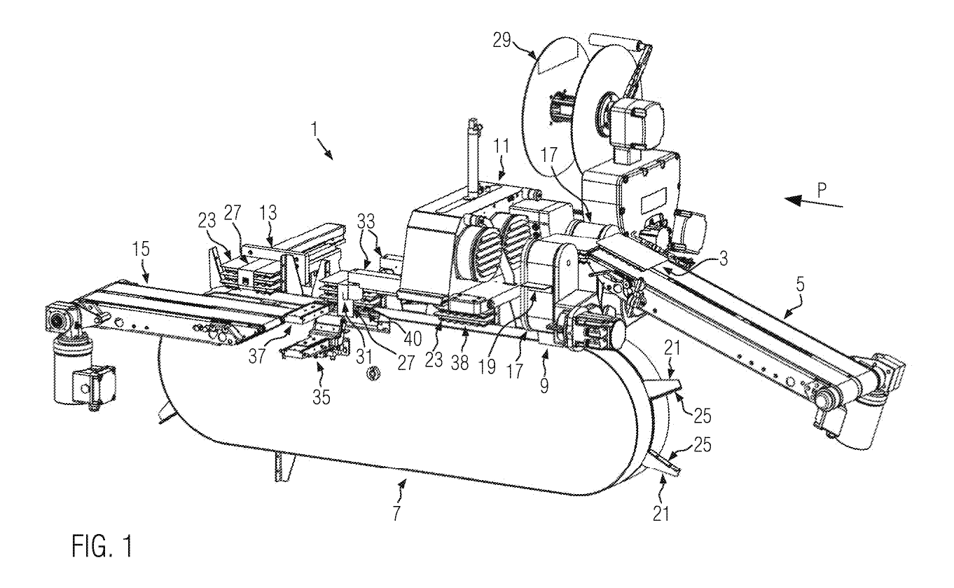

FIG. 1 shows a packaging machine 1 for grouping individual package units 3 in a perspective side view. The packaging machine 1 comprises a feeder 5, a conveying system 7, a grouping station 9 and a labeler 11. In addition, an optional pusher 13 and an optional discharge conveyor 15 are shown, which, depending on the respective production organization, may also be omitted or modified. The grouping station 9 comprises two substantially vertically oriented opposed toothed-belt conveyors 17 with carrier strips 19. The conveying system 7 comprises a plurality of movers 21, which can normally be moved individually using an electromagnetic mechanism. Using the grouping station 9, a respective package stack 23 is deposited between the sides of the movers 21, which have a stop 25, and clamped in position between the movers 21 with well-dosed force. In this way, two respective movers 21 move a package stack 23 along a production direction P on an upper side of the conveying system 7 and return to their starting position via a lower side of the conveying system 7. Labels 27 are supplied from a roll 29, which is here shown in an empty condition, and have at least one tab 31. For folding down and pressing-on the label 27, first rollers 33 and second rollers 35 are used, and for pressing-on the tab 31 a press plunger 37 is used. In order to make a lower surface 38 of the package stack 23 accessible for the second rollers 35 for pressing-on projecting ends of the label 27, the conveying system 7 has an opening 40 on both sides, which reduces the contact surface for the package stack 23 to a necessary minimum.

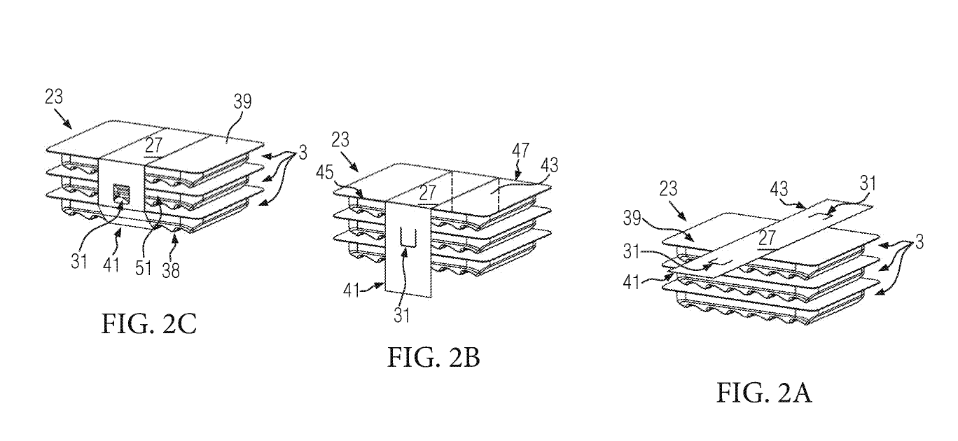

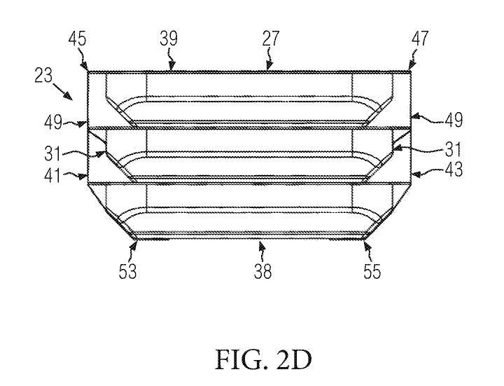

FIG. 2A shows a package stack 23 in a perspective side view, the package stack 23 comprising three package units 3 arranged one on top of the other and a label 27 that is applied to the upper surface 39 of the package stack 23, which also constitutes the upper surface of the uppermost package unit 3. The label 27 comprises a first and a second projecting end 41, 43 and one tab 31 per projecting end 41, 43.

FIG. 2B shows a perspective side view of a package stack 23 having a projecting end 41 folded down round a first upper edge 45 and a second projecting end 43 folded down round a second upper edge 47, only the first projecting end 41 being here visible due to the perspective view.

FIG. 2C shows a perspective side view of a package stack 23 having projecting ends 41, 43 pressed on the lower surface 38 of the package stack 23, which also constitutes the lower surface of the lowermost package unit 3, only the first projecting end 41 being here visible due to the perspective view. The tab 31, which is exemplarily cut or punched on three sides in the case of this embodiment, is pressed on a side face 51 of a central package unit 3.

FIG. 2D shows a front view of a package stack 23 having first and second projecting ends 41, 43 of the label 27 pressed on the lower surface 38 of the package stack 23, in accordance with FIG. 2C. It can be seen how the first and second projecting ends 41, 43 have been folded round a first and a second upper edge 45, 47 as well as a first and a second lower edge 53, 55 and have also adapted to the shape of the lateral side 49 of the package stack 23.

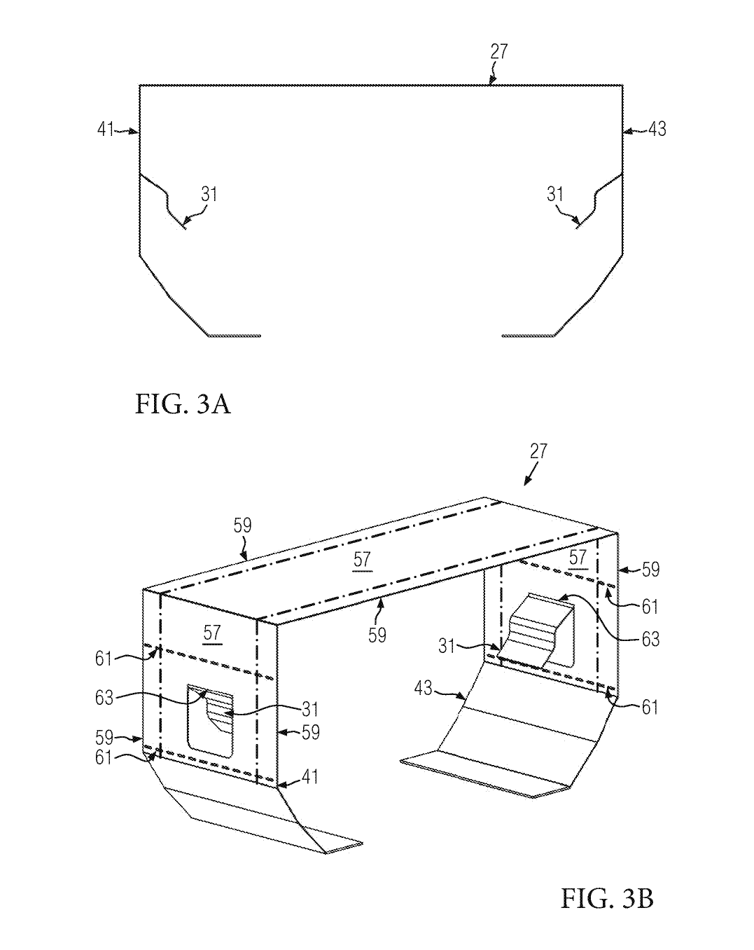

FIG. 3A shows a front view of a label 27 according to the present invention with two tabs 31, the respective tabs 31 being formed on a first and a second projecting end 41, 43. The label 27 and in particular the tabs 31 are shown in the form in which they have fully been pressed on the package stack 23 according to the preceding figures (the package units 3 are not shown). It can be seen that the label 27 and the tabs 31 are configured such that they are able to follow the shape of the package stack 23.

FIG. 3B shows a perspective side view of a label 27 according to the present invention with two tabs 31 in a pressed-on condition, in which, due to such pressing-on, parts of the first and second projecting ends 41, 43 as well as the tabs 31 follow the shape of the package stack 23 (the package units 3 are not shown). In the representation, a main surface 57 of the label 27 and of the first projecting end 41 and the second projecting end 43, respectively, is defined within the dot-and-dash lines, the main surface 57 being characterized in that it represents a suitable area for forming the tabs 31, since the area is sufficiently spaced apart from the label edges 59 of the label 27 for guaranteeing the stability of the label 27 also during punching or cutting of the tabs 31. The dashed lines represent possible perforations 61 at which the label 27 can be separated with a reasonable expenditure of force, so as to facilitate the opening of the package stack 23 and the separation of the package units 3. The tabs 31 are configured such that the areal adhesive connection, which the respective tabs 31 establish with a side face 51 of the central package unit 3, is larger than the thickness of the upper edge of the package unit 3 in all dimensions. Via a hinge side 63, the tabs 31 are articulated on the main surface 57 of the label 27 in a hinge-like manner.

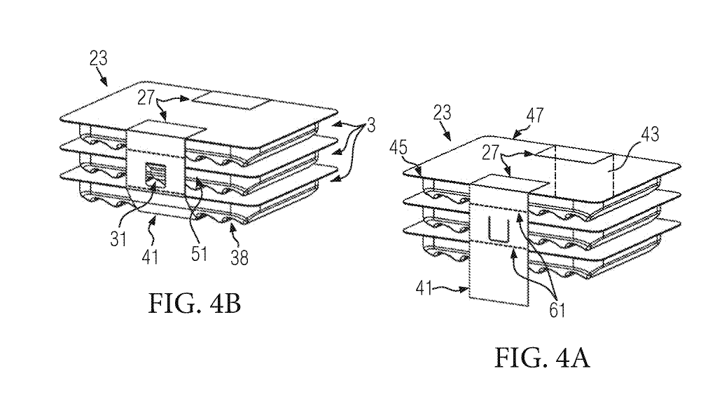

FIG. 4A shows a variant of a package stack 23 in a perspective side view with two separate labels 27, which each partially enclose one side of the package stack 23. The first projecting end 41 of the first label 27 is folded down round a first upper edge 45 and the second projecting end 43 of the second label 27 is folded down round a second upper edge 47.

FIG. 4B shows a perspective side view of a package stack 23 with projecting ends 41, 43 of the first and second labels 27 pressed on the lower surface 38 of the package stack 23 and with tabs 31 pressed on the sides face 51 of a central package unit 3. Also the second label 27 has a tab 31, which is here not visible due to the perspective view.

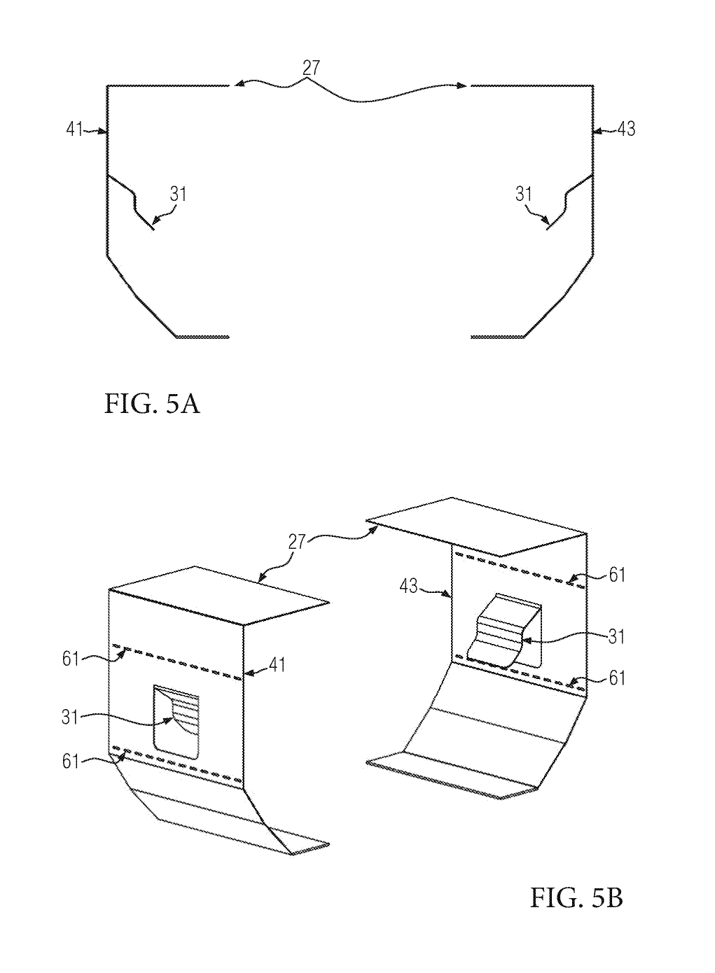

FIG. 5A shows a front view with a first and a second label 27 according to the present invention, each label 27 having a respective tab 31 formed on a first and on a second projecting end 41, 43. The labels 27 as well as in particular the tabs 31 are, analogously to FIG. 3A, shown in the form, in which they are fully pressed on the package stack 23 in correspondence with the preceding figures (the package units 3 are not shown).

FIG. 5B shows a perspective side view of a first and a second label 27 according to the present invention, each with a tab 31 in a pressed-on condition, in which, due to such pressing-on, parts of the first and second projecting ends 41, 43 as well as the tabs 31 follow the shape of the package stack 23.

As has already been explained with respect to FIG. 3B, also FIGS. 4A, 4B and 5B show optional perforations 61, which offer an improved possibility of separating the package units 3.

In the following, the mode of operation of the packaging machine 1 will be described in more detail making reference to the figures. Using the feeder 5, which may e.g. be a belt conveyor, the individual package units 3 are conveyed to the grouping station 9 and successively deposited therein from above between two toothed-belt conveyors 17. The toothed-belt conveyors 17 are provided with carrier strips 19, on which the package units 3 rest with a lower surface or a lateral edge thereof. The carrier strips 19, which expediently receive the package units 3 thereon at an upper position located adjacent to an edge of the feeder 5, are moved downwards using the toothed-belt conveyors 17, when the full number of package units 3 for a package stack 23 has been reached, so that the package stack 23 will be deposited on the conveying system 7 between two movers 21.

The movers 21, which can electronically be controlled individually and which have been positioned below the grouping station 9 before the package stack 23 has been deposited, then clamp the package stack 23 between their stops 25 and convey the package stack 23 to the labeler 11. In addition to the orientation of the package units 3 through the grouping station 9, also lateral guide rails may optionally be provided, which additionally orient the package units 3 of the package stack 23 while the latter is being conveyed to the labeler 11.

The labeler 11 may e.g. be a cross web labeler and may apply one or more labels 27 to the upper surface 39 of the package stack 23. In the case of conventional cross web labelers, labels 27 supplied from a roll 29 on a carrier are detached from the carrier at a stripping edge and positioned above the package stack 23 using a pneumatic system and pressed onto the package stack 23. In the course of this process, one or a plurality of labels 27 may be applied to the upper surface 39 of the package stack 23. According to the present invention, the label 27 is here positioned such that it has at least a first projecting end 41 beyond the package stack 23. According to an embodiment, the label 27 may also extend across the entire width of the package stack 23 and have a second projecting end 43 beyond the package stack 23 on a second side.

Once the label 27 is located essentially in the plane of the upper surface 39 of the package stack 23, after having been applied to the latter by the labeler 11, the first and the second projecting end 41, 43 will be folded, in a next step, round a first and a second upper edge 45, 47 and a first and a second lower edge 53, 55, so that the projecting ends 41, 43 will laterally enclose the package stack 23 essentially in a C-shape. In the embodiment shown in FIG. 1, the projecting ends 41, 43 are folded at the upper edges 45, 47 by first rollers 33 and at the lower edges 53, 55 by second rollers 35. The pressing-on may here take place passively by the first rollers 33 while the package stack 23 is moving along the production direction P, the first rollers 33 being arranged at a well-defined distance from the package stack 23 or with a well-defined elastic restoring force that is directed towards the package stack 23. Alternatively, the first rollers 33 may also be provided with an active drive for carrying out a forward and backward movement for pressing-on the projecting ends 41, 43. The same applies to the second rollers 35, which are shown in FIG. 1 in the active variant.

Using an active movement of a press plunger 37, the tab 31 is pressed onto a side face 51 of a central package unit 3. As shown, the tab 31 may have been punched or cut already prior to the application of the label 27 to the package stack 23. Alternatively, the punching may, however, also be carried out only immediately before the step of pressing-on the tab 31, using a suitably shaped cutting tool moved, for example, laterally against the label 27 encompassing the package stack 23. Generally speaking, the label 27 may either be pressed on directly at the site of the labeler 11 or, as shown, at a neighboring position along the production direction P, in the sense of a press-on station.

According to the embodiment shown, the finished package stack 23 is advanced by the movers 21 after the press-on operation, and is finally pushed by a pusher 13 onto a discharge conveyor 15, so as to be further advanced by the latter for stowing e.g. in a box. The movers 21 then return to their starting position via the lower side of the conveying system 7. A plurality of movers 21 may wait in a queue upstream of the grouping station 9. The further conveyance or the discharge of the package stack 23 after its completion is not limited to the above-described way, but may be carried out in any conceivable manner, for example through direct removal by a gripper arm or by an operator.

Starting from the above-described embodiment of a packaging machine 1, many variations of the latter are possible. For example, instead of stacking the individual package units 3 using a grouping station 9, they may also be stacked by moving the feeder 5 up and down. The feeder 5 will thus deposit the package units 3 directly on the conveying system 7. Optionally, a rear mover 21 may be caused to approach the respective package stack 23, when the feeder 5 is at an upper position. The labels 27 may also be pressed on directly on the site of the labeler 11. In this context, it is also imaginable that not only two labels 27, in the sense of a left and a right label 27, are applied, but that in the case of larger package units 3 also several labels 27 are applied, which are oriented parallel to one another. If one or several labels 27 are applied, which encompass the upper surface 39 of the package stack 23 according to FIG. 2A to 3B, certain areas of the labels 27 may be transparent, so that the upper surface 39 of the package stack 23 or of the uppermost package unit 3 can still be seen at least partially. Instead of making use of the rollers 33, 35 shown, the pressing-on and folding-down of the labels 27 may also be carried out by other mechanical devices, such as folding rails. Instead of the conveying system 7 shown, which comprises separately controllable movers 21, it would also be imaginable to use other conveying systems, such as linear belt conveyors with carrier strips. The tabs 31 are not limited to the form shown here, with three punched sides and one hingelike side, but may e.g. also be configured in a triangular shape with only two punched sides.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for grouping at least three package units into a package stack, the method comprising the steps of:
feeding the individual package units using a feeder to a grouping station;
stacking the package units one on top of the other through the grouping station so as to form a package stack;
depositing the package stack on a conveying system;
feeding the package stack to a labeler through the conveying system;
applying a label to the upper surface of the package stack through the labeler, the label having a lateral first projecting end that projects beyond the package stack;
folding the first projecting end of the label around a first upper and a first lower edge of the package stack;
pressing the first projecting end onto a lower surface of the package stack;
pressing at least one tab, which is connected to a main surface of the first projecting end in a hinge-like manner, onto a side face of a central package unit of the package stack.

2. The method according to claim 1, further comprising the step of folding a lateral second projecting end of the label around a second upper edge and a second lower edge of the package stack.

3. The method according to claim 2, further comprising the step of pressing the second projecting end onto the lower surface of the package stack.

4. The method according to claim 3, further comprising the step of pressing a second tab that is connected to the main surface of the second projecting end in a hinge-like manner onto a side face of a central package unit of the package stack.

5. The method according to claim 1, further comprising the step of applying a second label to the upper surface of the package stack, wherein the second label having a second projecting end that projects beyond the package stack.

6. The method according to claim 5, further comprising the step of folding the second projecting end of the second label around a second upper and a second lower edge of the package stack.

7. The method according to claim 6, further comprising the step of pressing the second projecting end of the second label onto the lower surface of the package stack.

8. The method according to claim 5, further comprising the step of pressing a second tab that is connected to a main surface of the second projecting end of the second label in a hinge-like manner onto a side face of the central package unit of the package stack.

9. A packaging machine for grouping individual package units, the packaging machine comprising a feeder and a conveying system, wherein it further comprises a grouping station and a labeler, the packaging machine being configured for stacking at least three package units one on top of the other so as to form a package stack and for encompassing the package stack, at least partially, with a label, the packaging machine comprising a press plunger, which is configured to press at least one hinge-like tab of the label onto a side face of a central package unit of the package stack.

10. The packaging machine according to claim 9, wherein the labeler is a cross web labeler.

11. The packaging machine according to claim 9, wherein the grouping station has two opposed toothed-belt conveyors with carrier strips, and that the grouping station is adjustable for grouping respective package units of different size.

12. The packaging machine according to claim 9, wherein the conveying system comprises separately movable movers, which are controllable for fixing package units and/or package stacks between two respective movers in a force-fitting manner.

13. The packaging machine according to claim 9, wherein the conveying system has an opening that allows the label to be pressed onto a lower surface of the package stack.

14. A package stack comprising:
an upper package unit;
a lower package unit; and
at least one central package unit, wherein the upper package unit, the lower package unit, and the at least one central package unit are stacked one on top of the other with the at least one central package unit being disposed between the upper and the lower package units; and
wherein the package stack further comprising at least one label that encompasses an upper surface, a lateral side and a lower surface of the package stack at least partially;
wherein the label comprises label edges and a main surface spaced apart from the label edges, the main surface comprising one or more tabs that are connected to the main surface in a hinge-like manner and are connected to a respective side face of the at least one central package unit of the package stack using an areal bond.

15. The package stack according to claim 14, wherein the label has at least one perforation, which, when the label has been applied to a package stack, is arranged preferably on the side in a horizontal direction and which is suitable to allow the package units to be separated from one another.
